(19) United States
(12) Patent Application Publication
(10) Pub. No.: US 2010/0206336 A1
(43) Pub. Date: Aug. 19, 2010

(54) EXTENDABLE VACUUM CLEANER

(76) Inventor: SAMI SOUID, Brooklyn, NY (US)

Correspondence Address: JAFARI LAW GROUP, P.C., 801 N. PARKCENTER DRIVE, SUITE 220, SANTA ANA, CA, 92705, US

(21) Appl. No.: 12/388,130

(22) Filed: Feb. 18, 2009

(51) Int. Cl. A47L 9/00; B08B 5/04

(52) U.S. Cl. 134/21; 15/347

(57) ABSTRACT

The invention is an extendable vacuum cleaner. More particularly, an apparatus in accordance with the present invention may comprise a housing for particulate collection, an intake unit for removably attaching to the housing, and one or more extenders coupled to the housing and intake unit, wherein each extender is adapted to extend and retract the intake unit from and to the housing. Exemplary use of an apparatus in accordance with the present invention may comprise of extending an intake unit away from a vacuum housing, moving the intake unit in a variety of directions so as to collect dust and clean underneath low clearance furniture, followed by retracting the intake unit towards the vacuum housing.

### TECHNICAL FIELD OF THE INVENTION

The present invention relates in general to an extendable vacuum cleaner, and more specifically, to an upright vacuum cleaner in which the intake port may be extended from and retracted to the vacuum body.

### COPYRIGHT & TRADEMARK NOTICE

A portion of the disclosure of this patent application may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### BACKGROUND OF THE INVENTION

Vacuum cleaners are used primarily for the removal and collection of dust and other particulates from a variety of surfaces. Because vacuum cleaners for personal use have been around for well over one hundred years, many advancements and new technologies have been developed to improve cleaning efficiency and function, as well as improve the vacuum's ease of use. Today, vacuums can be found in many different configurations, including canister, handheld, wet-dry, bagless, back-pack, and robotic to name a few. Yet, it is the upright vacuum configuration that remains most popular.

Typical upright vacuum cleaners may comprise an intake unit, an upright housing containing a particulate collector, and a motor and fan combination in order to create suction. Upright vacuum cleaners may further include a handle and wheels such that a user may push and pull the vacuum around during use. When in use, dust and other particulates are pulled into the vacuum due to a reduced pressure, where they are stored in the particulate collector for later disposal. As the user pushes and pulls the vacuum around, dust and particulates are removed from the floor.

While the upright vacuum cleaner's configuration may provide an economical, easy and even enjoyable means for cleaning the floors and carpets of most rooms, vacuuming underneath a low clearance area, such as below a bed or other piece of furniture, is frequently problematic. Because of the upright vacuum's dimensions, as one tries to clean further underneath the piece of furniture, the vacuum body must be lowered towards the floor to pass underneath the low clearance of the piece of furniture. Frequently, the housing section of the vacuum may be too large to fully maneuver the vacuum underneath low clearance furniture.

Due to the dimensions of an upright vacuum, a user may often be required to bend over or vacuum on their knees for extended periods of time in order to clean underneath low clearance furniture. Bending over, reaching down, or lowering onto one's knees may be a motion that is difficult or uncomfortable for many users. Additionally, the prospect of having to move heavy furniture in order to vacuum underneath is also undesirable, and for some users, even impossible.

To complicate matters, simply lowering the vacuum cleaner towards the floor to allow passage underneath a low clearance does not always provide the opportunity for a user to vacuum the entire area underneath the piece of furniture. Some pieces of furniture are too large, such as beds, for a user to reach and vacuum the entire floor area without some type of extension. While other vacuum configurations may provide the user alternative means of vacuuming below pieces of furniture with large dimensions, such as various removable wand attachments for upright vacuums, many users prefer the upright vacuum model. Further, in many instances, using the vacuum hose with a wand attachment to clean underneath low clearance furniture may be undesirable, as a user would still have to bend down or lower to their knees, the wand attachment has a small cleaning surface, and may be awkward to maneuver.

Thus, there is a need in the art for an upright vacuum that can pass underneath low clearance areas without requiring a user to bend or reach down. There is also a need for an upright vacuum in which the intake can extend away from the vacuum body in order to vacuum underneath large pieces of furniture. Specifically, there is a need for an upright vacuum cleaner in which the intake port may be extended from and retracted to the vacuum body, enabling the user to vacuum under low clearance furniture without having to bend over, reach down, or move furniture, in order to lower the angle of the vacuum body with respect to the floor. It is to these ends that the present invention has been developed.

### SUMMARY OF THE INVENTION

To minimize the limitations in the prior art, and to minimize other limitations that will be apparent upon reading and understanding the present specification, the present invention describes an upright vacuum cleaner in which the intake port may be extended from and retracted to the vacuum body, enabling the user to vacuum under low clearance furniture without having to bend or reach down in order to lower the angle of the vacuum body with respect to the floor.

An apparatus in accordance with the present invention may comprise a housing for particulate collection, an intake unit for removably attaching to the housing, and one or more extenders coupled to the housing and intake unit, wherein each extender is adapted to extend and retract the intake unit from and to the housing.

Additionally, an apparatus in accordance with the present invention may comprise a housing for particulate collection, a base port coupled to a lower portion of the housing, an intake unit for removably attaching to the base port, and one or more extenders coupled to the base port and intake unit, wherein each extender is adapted to extend and retract the intake unit from and to the base port.

Moreover, a method in accordance with the present invention may comprise the steps of extending an intake unit away from a vacuum housing, moving the intake unit in a variety of directions so as to collect dust, and retracting the intake unit towards the vacuum housing.

It is an objective of the present invention to provide a means of vacuuming underneath low clearance furniture.

It is another objective of the present invention to provide a method of using a vacuum to clean underneath low clearance furniture.

Finally, it is yet another objective of the present invention to allow a user of an upright vacuum cleaner a means of vacuuming underneath low clearance furniture without having to reach down, bend over, or move furniture.

These and other advantages and features of the present invention are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1(a) illustrates a perspective view of a vacuum with an intake unit extended away from the vacuum housing by an extender.

FIG. 1(b) illustrates a perspective view of a vacuum with an intake unit retracted to and coupled with the vacuum housing by an extender.

FIG. 1(c) illustrates a flow chart of a method of vacuuming in accordance with one embodiment of the present invention.

FIG. 2(a) illustrates a perspective view of a vacuum with an intake unit extended away from the base port by an extender.

FIG. 2(b) illustrates a perspective view of a vacuum with an intake unit retracted to and coupled with the base port by an extender.

FIG. 3 illustrates exemplary use of a vacuum in accordance with the present invention being used to clean under a low clearance area.

### DETAILED DESCRIPTION OF THE DRAWINGS

In the following discussion that addresses a number of embodiments and applications of the present invention, reference is made to the accompanying drawings that form a part hereof, where depictions are made, by way of illustration, of specific embodiments in which the invention may be practiced. It is to be understood that other embodiments may be utilized and changes may be made without departing from the scope of the present invention.

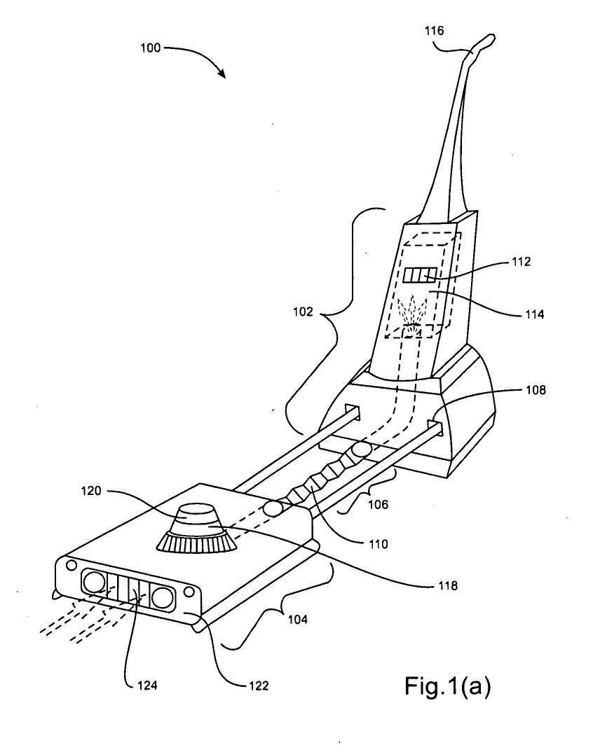

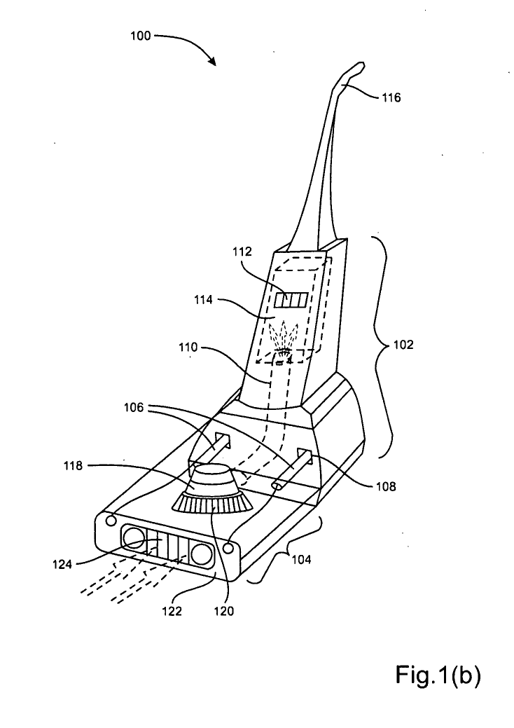

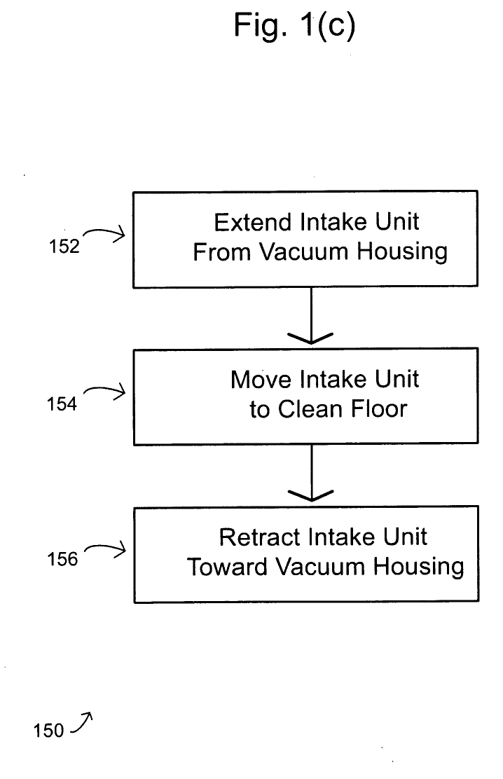

FIG. 1(a) illustrates a perspective view of a vacuum with an intake unit extended away from the vacuum housing by an extender. FIG. 1(b) illustrates a perspective view of a vacuum with an intake unit retracted to and coupled with the vacuum housing by an extender.

FIGS. 1(a) and 1(b) show vacuum 100, comprising housing 102, intake unit 104, extender 106, actuator 108, hose 110, exhaust port 112, filter 114, handle 116, motor 118, fan 120, intake port 122, and rotating brush 124. Vacuum 100 is designed to collect dust and particulate matter in housing 102 via a negative pressure through intake unit 104, but to also allow for intake unit 104 to be extended away from and retracted to housing 102 via extenders 106, enabling a user to more easily vacuum under low clearance furniture. Vacuum 100 may be used upon a variety of surfaces, including carpets or upholstery, dry surfaces, such as wood, tile, ceramics, marble, or upon wet surfaces. This list is not exhaustive, however, and should not be interpreted so as to limit the scope of the present invention.

Housing 102 is the central body of vacuum 100. Housing 102 may comprise any container or like device that allows for particulate collection. In a preferred embodiment, housing 102 may be removable from vacuum 100 such that dust and particulate matter may be disposed of after collection. Housing 102, however, may also be a fixed component of vacuum 100, such that a removable dust bag or other like container may be situated inside housing 102 to collect and dispose of dust and other particulate matter.

Intake unit 104 is an extendable body of vacuum 100 in which dust and other particulates may enter via intake port 122. In a preferred embodiment, air flows into intake unit 104 through intake port 122 due to a negative pressure created by fan 120 and motor 118. Air flow travels through intake port 122 into hose 108 to housing 102, where dust and other particulates are collected for storage and disposal. Air may exit housing 102 via exhaust port 112, which may be located on a side of housing 102.

Intake unit 104 may include a video camera. In such an embodiment, a video camera may be affixed on intake unit 104 such that visual images of the vacuuming area may be taken by said video camera. In such an embodiment of the present invention, housing 102 may include a video screen. The video screen may be affixed on housing 102 such that video images may be viewed during use of vacuum 100. The video camera upon intake unit 104 may be connected to the video screen upon housing 102 by either a wired or wireless connection. As such, exemplary use of such an embodiment of the present invention may include viewing a video screen mounted upon housing 102 displaying images of the surface below intake unit 104.

Intake unit 104 may be coupled to housing 102 via extender 106. Vacuum 100 may include one or more extenders 106. In a preferred embodiment, extender 106 may extend and retract intake unit 104 from and to housing 102 through adjustable length. In a preferred embodiment, extenders 106 may be composed of telescopic rods, extending and retracting intake unit 104 from and to housing 102 by collapsing and expanding in length. In another exemplary embodiment, extenders 106 may be composed of two or more parallel members connected at joints, wherein the length of extender 106 is variable by the members extending in and out in parallel motion. Additionally, extender 106 may function by means such as screw-rotation motion, an air or pneumatic expansion or retraction, or some type of material based elasticity.

Preferably, extenders 106 are rigid such that the movement of intake unit 104 may be one dimensional, meaning that the extenders 106 and intake unit 104 may only extend back and forth with respect to housing 102 and may not flex from side to side or up and down. However, in other embodiments of vacuum 100, intake unit 104 may be extended from and retracted to housing 102 by extender 106 in a plurality of directions, meaning that intake unit 104 is not limited to lateral movement with respect to housing 102.

In a preferred embodiment, extender 106 is activated by actuator 108. Actuator 108 may be a mechanical or electrical component that adjusts the length of extender 106 so as to extend or retract intake unit 104. Preferably, actuator 108 may be located in or proximate to housing 102. However, actuator 108 may be coupled to intake unit 104. In another exemplary embodiment, extender 106 may be manually activated by the user, thereby moving intake unit 104. In such an embodiment, the user may activate extender 106 by releasing a lock, thereby allowing user to extend or retract extender 106. When the desired length of extender 106 is achieved, the user may lock extender 106's length, at which point the desired distance between housing 102 and intake unit 104 remains fixed until user releases the lock again for length alternation of extender 106.

Hose 110 is a pressurized conduit in which air flow, dust and other matter may be transferred from intake unit 104 to housing 102. As such, hose 110 may be coupled to intake port 122 and housing 102. In a preferred embodiment, hose 110 may be corrugated such that it may be extendable and retractable. However, hose 110 may be telescopic in nature such that it may extend to and retract from housing 102. Additionally, hose 110 may have a length equal to the maximum distance between intake unit 104 and housing 102, and may fold, roll, or bunch up inside housing 102 when intake unit 104 is retracted some distance back toward housing 102. Further, hose 110 could be composed of an elastic material such that its length may be variable, allowing extension and retraction of intake unit 104 from and to housing 102.

Air flow may exit vacuum 100 through exhaust port 112 as dust and other particulates are collected in housing 102. In a preferred embodiment, exhaust port 112 is located on the body of, or proximate to, housing 102. Filter 114 may remove airborne dust and particulate matter from air flowing out of exhaust port 114, increasing quality of exhausted air. Filter 114 may be securely attached on either side of exhaust port 112. In a preferred embodiment, filter 114 may be detached for cleaning of filter 114, or filter 114 may be replaceable. In yet another embodiment, vacuum 100 may not include filter 114.

Handle 116 is a component that may be coupled to housing 102. In exemplary usage, a user may push and pull vacuum 100 by handle 116 in order to maneuver the device.

Motor 118 may power fan 120, which in combination may create a negative pressure used by vacuum 100 to collect in dust and other particulate matter in housing 102. Motor 118, in a preferred embodiment, may be electrical in nature; however, in other embodiments motor 118 may power fan 120 by combustion or some other chemical-based reaction. Further, the location of motor 118 and fan 120 within vacuum 100 may be varied. In one embodiment, motor 118 and fan 120 may be coupled to intake unit 104; however, in other embodiments, motor 118 and fan 120 may be adjacent or proximate to housing 102.

Motor 118 may power components to vacuum 100 in addition to fan 120. In one such embodiment, motor 118 may activate extender 106 in addition to providing power to fan 120. In another embodiment, motor 118 may power rotating brush 124. Rotating brush 124 is a component that may be coupled to intake unit 104, and may loosen particulate matter and larger objects from the surface being cleaned by vacuum 100. Additionally, motor 118 may provide electrical power for optional lighting that may be affixed on intake unit 104 or housing 102.

FIG. 1(c) illustrates a flow chart of method 150, which may be employed by a user of a vacuum 100, or another vacuum in accordance with one embodiment of the present invention. Method 150 is explained in the order shown below; however, the following steps may be taken in any other conceivable sequence, or with additional steps not discussed, without deviating from the scope of the present invention.

In step 152, a user may extend intake unit 104 away from housing 102. Extending intake unit 104 may comprise of activating actuator 108 to extend extender 106; however, extending intake unit 104 may be accomplished manually. After step 152 is accomplished, a user may continue to step 154.

In step 154, a user may move vacuum 100 in a variety of directions, moving intake unit 104 such that dust and other particulates may be collected, cleaning the floor. In exemplary usage, a user may shift vacuum 100 such that intake unit 104 moves under low clearance furniture, thereby allowing a user to clean underneath said low clearance furniture. A user, however, may vacuum any floor surface with intake unit 104 extended away from housing 102; it is not required that a user use vacuum 100 to clean underneath low clearance furniture when intake unit 104 is in an extended position. When a user has decided to retract intake unit 104, the user may continue to step 156.

In step 156, a user may retract intake unit 104 towards housing 102. Retracting intake unit 104 may comprise activating actuator 108 to retract extender 106; however, retracting intake unit 104 may be accomplished manually.

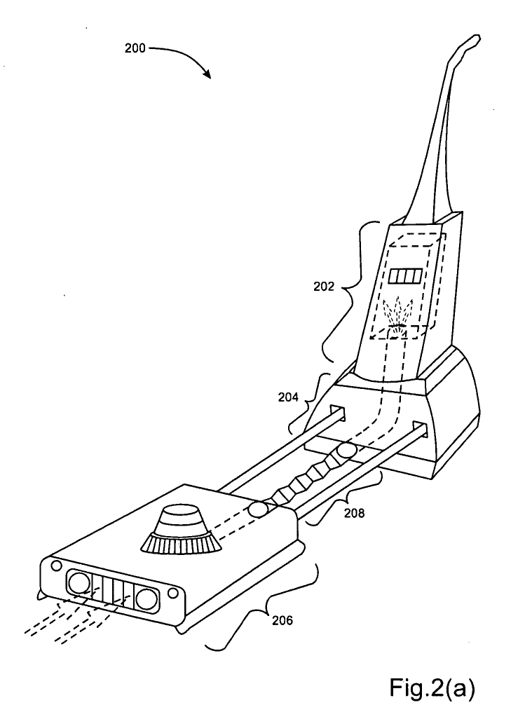

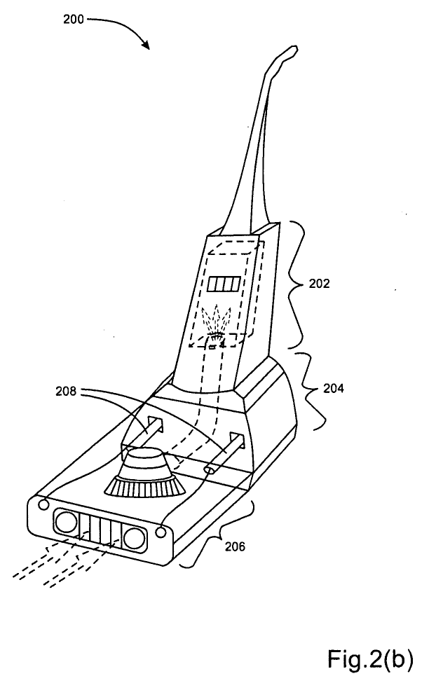

A vacuum in accordance with the present invention may contain a housing, an intake unit, and an extender, as previously described. However, a vacuum in accordance with the present invention may also contain a base port. FIG. 2(a) illustrates a perspective view of a vacuum with an intake unit extended away from the base port by an extender. FIG. 2(b) illustrates a perspective view of a vacuum with an intake unit retracted to and coupled with the base port by an extender. FIGS. 2(a) and 2(b) show vacuum 200, comprising housing 202, base port 204, intake unit 206, and extender 208. Vacuum 200 is designed for intake unit 206 to be extended away from and retracted to base port 204 via extenders 208.

Base port 204 may couple housing 202 to extender 208. In such an embodiment, base port 204 may be designed to provide a pivot for housing 202 such that the angle of vacuum 100 may be may be adjusted as compared to the floor. Thus, a user may pivot housing 202 upon base port 204.

Extender 208 may couple intake unit 206 to base port 204. In such an embodiment, intake unit 206 may extend from and retract to base port 204 by extender 208. Extender 208 may be activated by an actuator, which may be located in or proximate to base port 204.

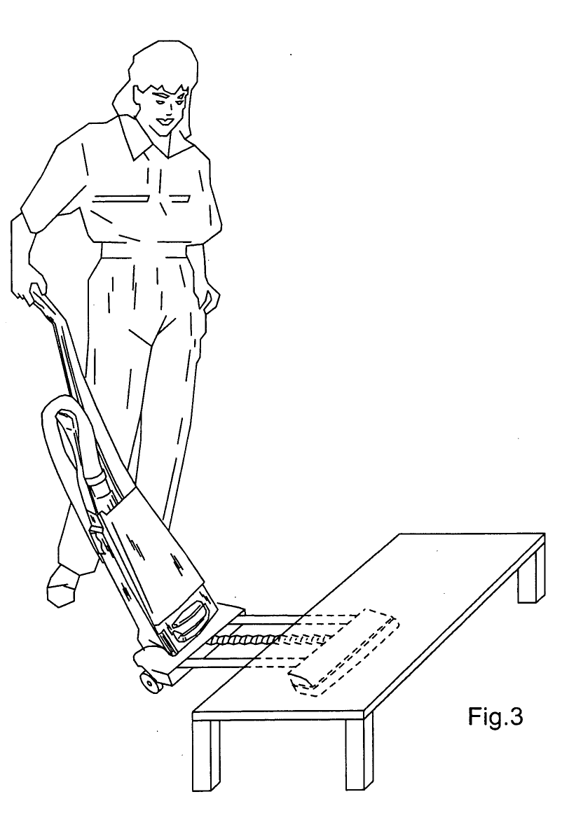

FIG. 3 illustrates exemplary use of a vacuum in accordance with the present invention being used to clean under a low clearance area. As illustrated in FIG. 3, a user may reach further underneath a piece of low clearance furniture, without having to lower the housing of the vacuum towards the floor, when the intake unit of a vacuum in accordance with the present invention is in an extended position.

A vacuum and method has thus been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A vacuum comprising:
a housing for particulate collection;
an intake unit for removably attaching to the housing; and
one or more extenders coupled to the housing and intake unit, wherein each extender is adapted to extend and retract the intake unit from and to the housing.

2. The vacuum of claim 1, wherein the intake unit further comprises a fan driven by a motor.

3. The vacuum of claim 2, wherein the motor and fan are proximate to the housing.

4. The vacuum of claim 2, wherein the motor and fan are adjacent to the housing.

5. The vacuum of claim 1, wherein an extender is comprised of telescopic rods.

6. The vacuum of claim 1, wherein an extender is comprised of two or more parallel members connected at joints.

7. The vacuum of claim 1, wherein an extender may function by means of a screw-rotation motion.

8. The vacuum of claim 1, wherein an extender may function by means of a pneumatic expansion or retraction motion.

9. The vacuum of claim 1, wherein the housing includes an actuator for extending and retracting the intake unit.

10. The vacuum of claim 1, wherein a handle is coupled to the vacuum housing.

11. The vacuum of claim 1, wherein the intake unit suctions in dust via a negative pressure created by the fan and motor.

12. The vacuum of claim 1, wherein an extendable and retractable hose fluidly couples the intake unit to the dust bag housing.

13. The vacuum of claim 12, wherein dust is collected in the housing for particulate collection via the extendable and retractable hose.

14. The vacuum of claim 1, wherein the housing for particulate collection includes an exhaust port.

15. The vacuum of claim 1, wherein lighting may be coupled to the intake port.

16. The vacuum of claim 1, wherein the vacuum motor is coupled to an extender for activating the extension and retraction of the intake port from and to the base port.

17. The vacuum of claim 1, wherein the housing further comprises a locking mechanism to couple the intake unit to the base port.

18. The vacuum of claim 1, wherein the intake unit may be mechanically extended or retracted from the base port via extenders.

19. The vacuum of claim 1, wherein the housing for particulate collection includes a replaceable dust bag.

20. The vacuum of claim 1, wherein the housing for particulate collection includes an air filter.

21. The vacuum of claim 1, wherein the intake unit includes a rotating brush for large particulate pick up.

22. The vacuum of claim 1, wherein the intake includes a video camera.

23. The vacuum of claim 1, wherein the housing includes a video screen.

24. A method of vacuuming, comprising:
extending an intake unit away from a vacuum housing;
moving the intake unit in a variety of directions so as to collect dust; and
retracting the intake unit towards the vacuum housing.

25. The method of claim 24, wherein extending comprises activating an actuator to extend extenders coupled to the intake unit such that the intake unit is moved away from the vacuum housing.

26. The method of claim 24, wherein retracting comprises activating an actuator to retract extenders coupled to the intake unit such that the intake unit is moved towards the vacuum housing.

27. A vacuum comprising:
a housing for particulate collection;
a base port coupled to a lower portion of the housing;
an intake unit for removably attaching to the base port; and one or more extenders coupled to the base port and intake unit, wherein each extender is adapted to extend and retract the intake unit from and to the base port.
